(19) United States
(12) Patent Application Publication
(10) Pub. No.: US 2026/0185374 A1
(43) Pub. Date: Jul. 2, 2026

(54) VEHICLE MOUNTED SHELTER

(71) Applicant: ON TOP TOURERS PTY LTD, Safety Bay, Western Australia (AU)

(72) Inventors: Daniel Royce WATTS, Aitkenvale (AU); Stanzee Keira WATTS, Aitkenvale (AU)

(21) Appl. No.: 18/997,429

(22) PCT Filed: Jul. 21, 2023
(86) PCT No.: PCT/AU2023/050670

§ 371 Date: Jan. 21, 2025

(30) Foreign Application Priority Data
Jul. 21, 2022 (AU) 2022902042

(51) Int. Cl. E04H 15/06; E04H 15/18

(52) U.S. Cl. CPC E04H 15/06; E04H 15/18

(57) ABSTRACT

The invention relates to a vehicle mounted shelter for accommodating sleeping couples or a family, including a first deck and second deck, generally horizontally disposed and sized to accommodate a sleeping couple. The invention also provides variants thereon and a method of use.

### FIELD OF THE INVENTION

The present invention relates to a vehicle mounted shelter, and in particular to a vehicle mounted shelter adapted to be located over the roof or load space of a vehicle.

### BACKGROUND OF THE INVENTION

Camping is a most popular pastime, and one form of camping is using a roof top tent arrangement that opens up and extends out to the side of the vehicle. These forms of roof top campers gained support as may people are worried about the proximity of snakes or other animals when sleeping on the ground. Further these known forms of roof top camper transform from a form that is readily transported and packed away on the roof of the vehicle to open up to create a safe sleeping shelter, accessible through a ladder. The storage issues for tents, or the loss of storage as for a camper trailer are overcome, as roof top campers simply are installed to the roof and the rest of the vehicle, tub and or trailer can be used as usual. Various supports and additional structures are used on known roof top campers including struts and legs to support the shelter and to create an awning to include a shaded area for sitting, cooking and working.

Each of these known roof top campers extends out the side of the vehicle, and outside the general footprint of the vehicle when opened up, to enable access. These known roof top campers have been around for more than 60 years, and while small changes in materials have made these lighter and easier to use, significant fundamental changes to the design have not been made over this time. The larger footprint and space needed to use a roof top camper is undesirable but until now there has not be a suitable solution to address this issue.

These known roof top tents are useful to accommodate one person, or a couple, using the roof of a vehicle to store the sleeping accommodation and host it in use. However, land based tents offer the benefit of multiple rooms for more people or a family. These larger tents include separate rooms, to allow greater space and separation when sleeping of the people inside and including internal doors for privacy when sleeping. Provision of more space, and accommodation for two couples, or a couple and children, with space to move and separated privacy has long been a desired form of roof top camper. In this way all the advantages of a roof top camper may be captures, but useful for more then two people.

However, it is not that easy to achieve this end, as has been found by designers in the industry over the years who have not be able to solve these problems. The roof top campers of a known form utilise the load bearing of the roof and as such are limited by the roof of the vehicle and to extend out in order that the sleeping “floor” is suitably supported. However, it would be most beneficial to be able to achieve this form of roof top camper that has some of the advantages of land based tents, having separate areas for more than one couple to sleep, or children, with a privacy screen and physical separation for comfort. Even where the people are extended family or good friends, it is preferable to have some space between sleep adults.

There are significant structural difficulties to increase the supportive platform for supporting two couples sleeping, but the inventors have through long and careful research developed a surprising means to do so. In so doing they have invented a highly beneficial separated sleeping quarters, within the footprint of the vehicle and with space as well as a privacy screen. The ability for the couples to sleep toe to toe, for example, rather than sardine fashion next to one another is a significant advantages as it allows dramatically increased social comfort for couples sharing the roof top tent, not provided by any available prior art system. The physical barriers overcome using the support of the vehicle and keeping within the footprint, while accommodating two couples or a family, enables sleeping accommodation to be comfortably provided within the vehicle footprint rather than needing the extended space of a family tent, or fold out camper van.

With caravan parks transforming to minimised parking spaces, this is advantageous as it means a family can stay in a standard sized block without needing extra room. At outback camp spots, such as popular fishing spots, or during school holidays where space may be difficult to find, the smaller footprint is likewise advantageous. Where the terrain is not flat use of more extended campers, or struts may not be possible, or safe. With use of the subject invention the benefits of being secure on the top of a vehicle may be achieved, for more than one couple or for a family, with privacy and comfort. This may in fact enable camping to take place at otherwise difficult to stay locations, such as where the ground is damp, hard or rocky and would be uncomfortable for tent ground camping but roof top camping for the more than one couple or family can now be achieved. All in all the inventors have overcome some long felt difficulties to develop this clever new invention that is likely to be very well received once known about.

The following describes a non-limiting example of the invention being used on a recreational vehicle as a useful example. It is not intended to limit the invention to any particular vehicle, other than as defined in the claims, and other standard vehicles may also be used with the invention.

For clarity, any prior art referred to herein, does not constitute an admission that the prior art forms part of the common general knowledge in Australia or elsewhere.

It is an object of the present invention to provide a vehicle mounted shelter that at least ameliorates one or more of the aforementioned problems of the prior art. It is a further and separate object of the present invention to provide a method of use of a vehicle mounted shelter that at least ameliorates one or more of the aforementioned problems of the prior art.

### DISCLOSURE OF THE INVENTION

Accordingly, the invention provides a vehicle mounted shelter for accommodating sleeping couples or a family, the vehicle mounted shelter including:
a first deck, generally horizontally disposed and sized to accommodate a sleeping couple; and
a second deck, generally horizontally disposed and sized to accommodate a sleeping couple;
   wherein the shelter is moveable between a closed state for storage or transport with the vehicle, and an open state where the decks are accessible for sleeping.

Accordingly, the present invention provides a vehicle mounted shelter for accommodating sleeping couples or a family, the vehicle mounted shelter including:
a first deck, generally horizontally disposed and sized to accommodate a sleeping couple; and
a second deck, generally horizontally disposed and sized to accommodate a sleeping couple;
   wherein the sleeping couple lie side by side, transverse the axle of the vehicle, and the shelter does not substantially exceed the width of the vehicle footprint.

The vehicle mounting may be in the form of a capsule, pop-up or other suitable form of roof top mounting during transportation or storage. The mounting may be through use of conventional roof racks. The mounting may include direct installation to the vehicle.

The vehicle may be a recreational vehicle. The vehicle may be any suitable vehicle. The vehicle may be a vehicle and trailer. The trailer may be used to support the invention within the footprint of the trailer rather than the vehicle. The vehicle may include a tub or rear loading area. The shelter may be mounted above the vehicle roof or loading area. The shelter may be mounted above a tub, or trailer in other forms of the invention.

Preferably, the shelter is collapsed and protected for transport and then provides suitable sleeping accommodation for the sleeping couples in use. Preferably, the accommodation is a temporary accommodation for comfortable sleeping. The accommodation may be used on trip away from home to stay at a camp site or national park, or other outdoor place. The accommodation is suitable for sleeping overnight.

Preferably, the sleeping couples that can be accommodated is at least two adult couples. A whole family, two parents and two or more small children may be accommodated in separated and private rooms, through use of the invention. Part of the real benefit of the invention is the ability to enable two couples, or a whole family to be accommodated in a separated, private fashion, a significant improvement over the prior art. While the sizing allows for the couples to stay, other occupancy is of course possible. As would be readily understood, the accommodation is sized to suit two adult couples, one in each “room” above a deck but could be used by two people separately, a couple and a single person or a couple or single person and then one or more children in the other room. Any other suitable use of the invention may be made as would be understood. The particular size of the decks or rooms may be varied within the scope of the invention. The sizing of the accommodation may be any suitable size able to accommodate a sleeping couple. Preferably, the sizing enables a sleeping couple to lie conventionally, and a second sleeping couple also to lie conventionally but toe to toe to maximise the spaced separation while sharing the same accommodation. The size may be to suit adults of 1.7 metres to 1.9 metres tall. The adults may be of average height. The family accommodation may be any suitable combination of adults and children, the added size and increased privacy for the adults of great benefit throughout.

Preferably, each deck is sized somewhat like a double camping mattress suitable to accommodate a couple of sleeping adults. The deck be adapted to readily receive a mattress or similar, or may include the mattress itself.

Each deck is a carefully constructed part of the invention. Generally the deck is substantially rectangular. Shaping to at least one part of a deck, say one end may be included such as a curved end. There may be any suitable number of decks. A pair of foldable decks foldable one over the other is preferably for storage and creating the sleeping accommodation in use. The decks may be the same or different from one another. Preferably, the decks are generally configured similarly to accommodate the pair of sleeping adult couples but also to make them readily substantially stackable.

Preferably, at least two decks are included. Optionally more than two decks are included. Preferably, the first deck may be locatable above the second deck for transportation. The decks may be slidably related. The decks may be stacked for storage and transportation. Or the decks may be stored in a configuration where they do not substantially overlap one another. One deck may slide over the other during storage or transportation and be slide apart for use. The first deck may be adapted to be locatable over the second deck by folding. The first and second decks may be hingeably connected. Where the first and second decks are hingeably connected the first deck and second deck may be unfolded from the stored or transport state to an extended state, unfolded state, for use.

The generally horizontal disposition of the decks is substantially parallel a roof of the vehicle. Preferably, the decks are stacked or folded one on the other in a generally horizontal plane during storage and unstacked or unfolded for use, but remain in the horizontal plane, substantially parallel the roof of the vehicle for sleeping.

Preferably, a fall barrier is included for the sleeping persons. Preferably, the fall barrier extends from at least one deck. Preferably, the fall barrier extends from the or each deck. The fall barrier may take any suitable form. The fall barrier may include a wall extending upwards from the deck. The wall may be made of any suitable material. The wall may be made of any suitable material chosen from the following group: aluminium; plywood; plastics; composite; or a combination thereof.

A canopy of any suitable form may be included. Preferably, the vehicle mounted shelter accommodation includes a collapsible canopy, erectable above the decks. Preferably, the collapsible canopy provides a roof and support above the sleeping persons in use. Preferably, the canopy is formed in supported sections for ready collapse and erection. Preferably, the canopy opens and closes with the opening and closing of the pair of decks during opening and closing, in a convenient manner.

Preferably, at least one privacy barrier is included. Preferably, a privacy barrier is included between the decks. Preferably, two distinct chambers or divisions are created one associated with each deck by the privacy barrier being between them. Preferably, the privacy barrier is adapted to provide a visual barrier between the two chambers or divisions created by the two decks. Preferably, the privacy barrier substantially prevents a person from seeing between the two chambers or divisions created by the decks when the privacy chamber is in place. Preferably, the privacy barrier is a physical barrier between the chambers. Preferably, the privacy barrier substantially dampens sounds between the chambers. In some forms of the invention the privacy barrier may substantially soundproof the chambers one from the other. The privacy barrier may be connected to the canopy. The privacy barrier may be connected to one or more decks. The privacy barrier may be connected in any suitable manner. The privacy barrier may be connected to both the canopy and the deck to provide a strong and suitable privacy barrier for use. Preferably, the privacy barrier runs from a deck in vertical grooves to a ceiling/the canopy. Rails or guides may be included instead and the privacy barrier may be run from the floor to ceiling in the guide rails. The privacy barrier may extend from a deck in rails to a ceiling. The privacy barrier may extend between a floor and ceiling and any suitable manner. The privacy barrier may be erected after opening up of the decks and canopy and attached to the canopy to complete the assembly.

The vehicle mounted shelter accommodation may include divisions. The vehicle mounted shelter accommodation may include first and second divisions. The vehicle mounted shelter accommodation may include first and second divisions positioned end to end in a first configuration for sleeping and being positionable one over the other in second configuration for transportation on the vehicle.

Preferably, each division is sized to accommodate one of the couples. Each division may include a deck, wherein the decks are hingedly connected along respective adjacent edges running parallel with the axles of the vehicle. Preferably, each of these decks includes a fall barrier. The fall barrier may include a wall erected peripherally in relation to the deck.

Most preferably, a privacy barrier is included between the divisions. Preferably, the privacy barrier is associated with the decks. Preferably, the privacy barrier substantially isolates the two divisions or sleeping chambers suitable for comfortable private accommodation by two sleeping couples. Preferably, the privacy barrier substantially blocks the view between the divisions. Preferably, the privacy barrier substantially blocks sound between the chambers.

Preferably, supports are included, and the supports support the deck over the front of the vehicle. The supports may support in any suitable configuration whereby the decks are maintained substantially within the vehicle footprint. Preferably, the decks extend from the roof forward over the bonnet in one form of the invention. In another form of the invention the decks may extend over the tub or load carrying part of the vehicle. In either form the supports are preferably kept substantially within the footprint of the vehicle in use. The legs may be telescopic legs. Preferably, the legs are readily used telescopic legs to extend from the vehicle mounted shelter to support one or more deck in use. Folding and telescopic actions may be used in the extension of the supports to the support the decks in use.

Most preferably, the invention provides a double roomed sleeping accommodation, with privacy barrier, provided from a roof top of a vehicle and when erected the footprint is substantially within the vehicle footprint. Preferably, the decks extend longitudinally along the vehicle in use. Preferably, no lateral extension is required.

Accordingly, in a variant, the invention provides a vehicle mountable capsule having a removable lid covering a tray defined by a floor and an upstanding connected side, the lid being displaceable to expose the floor and, when displaced, the lid and the floor each defining a deck providing a planar area sized for occupation by an adult human couple lying lengthwise side by side and transverse to an axle of the vehicle on which it is mounted.

Accordingly, in a further variant, the invention provides a vehicle having mounted above it, and not substantially exceeding its footprint width, sleeping accommodation including a sleeping area wide enough for occupation by one adult human couple and long enough for occupation by two adult human couples lying end to end and orthogonally relative to the axial direction of an axle of the vehicle.

Accordingly, the present invention provides in a variant a vehicle mounted shelter for accommodating two sleeping couples or a family, the vehicle mounted shelter including
a first deck, generally horizontally disposed and sized to accommodate a sleeping couple; and
a second deck, generally horizontally disposed and sized to accommodate a sleeping couple;
   wherein the sleeping couple lie side by side, transverse the axle of the vehicle, and the sleeping couples lie toe to toe to one another, and are separated by a privacy barrier between the deck and a canopy forming a roof of the accommodation and the shelter does not substantially exceed the width of the vehicle footprint.

Accordingly, the present invention provides in a further variant a vehicle mounted shelter for accommodating two sleeping couples or a family, the vehicle mounted shelter including
a first deck, generally horizontally disposed and sized to accommodate a sleeping couple;
a second deck, generally horizontally disposed and sized to accommodate a sleeping couple; and
a privacy barrier adapted to be erected between the first deck and the second deck and a protective canopy, the privacy barrier adapted to substantially screen visually and aurally between the two chambers created associated with each deck,
   wherein the sleeping couple lie side by side, transverse the axle of the vehicle, and the sleeping couples lie toe to toe to one another, and are separated by a privacy barrier and protected by the canopy, and the shelter does not substantially exceed the width of the vehicle footprint.

These variant vehicle mounted shelters may include one or more other features of the invention.

Accordingly, the invention also provides a method of use of a vehicle mounted shelter including a first deck, generally horizontally disposed and sized to accommodate a sleeping couple and a second deck, generally horizontally disposed and sized to accommodate a sleeping couple, the method including:
a) storing the decks on the roof of the vehicle during transport or storage;
b) using the decks as sleeping accommodation by first parting the stored decks to form two decks suitable for two sleeping couples to sleep toe to toe and installing a privacy screen therebetween,
   wherein the sleeping couple lie side by side, transverse the axle of the vehicle, and the shelter does not substantially exceed the width of the vehicle footprint.

The invention of the method may be the invention accordingly any of the forms or variants.

### INDUSTRIAL APPLICABILITY

The invention is to be manufactured industrially and supplied to wholesalers and retailers, or to customers directly, for installation and use with their vehicles.

### BRIEF DESCRIPTION OF THE DRAWINGS

The invention will now be described in connection with a non-limiting preferred embodiment with reference to the accompanying drawings, in which:

FIG. 1 illustrates in schematic form an oblique view of a first preferred embodiment of the vehicle mounted shelter of the invention, mounted on a vehicle;

FIG. 2 is a schematic rear end view of the vehicle mounted shelter of FIG. 1;

FIG. 3 is a schematic side view of the vehicle mounted shelter of FIG. 1;

FIG. 4 illustrates in plan view the vehicle mounted shelter of FIG. 1, without any covering canopy in place but with supporting members for the canopy fabric folded down in readiness for transport;

FIG. 5 (none);

FIG. 6 is a side view of a second preferred embodiment of the vehicle mounted shelter the invention in open configuration, unmounted including F6(a) and F6(b), detail inserts of FIG. 6;

FIG. 7 is a plan view of the apparatus of FIG. 6 in open configuration, unmounted;

FIG. 8 is a schematic left rear perspective view of the vehicle mounted shelter of FIG. 6, mounted to a vehicle, in open configuration;

FIG. 9 is a schematic top view of the vehicle mounted shelter of FIG. 6, mounted as in FIG. 8, to a vehicle, in open configuration;

FIG. 10 is a schematic rear view of the vehicle mounted shelter of FIG. 6, mounted, as in FIG. 8, to a vehicle, in open configuration;

FIG. 11 is a schematic front view of the vehicle mounted shelter of FIG. 6, mounted, as in FIG. 8, to a vehicle, in open configuration;

FIG. 12 is a schematic left side view of the vehicle mounted shelter of FIG. 6, mounted, as in FIG. 8, to a vehicle, in open configuration;

FIG. 13 is a schematic right hand side view of the vehicle mounted shelter of FIG. 6, mounted, as in FIG. 8, to a vehicle, in closed capsule configuration;

FIG. 14 is a schematic front end view of the vehicle mounted shelter of FIG. 6, mounted, as in FIG. 8, to a vehicle, in closed capsule configuration;

FIG. 15 is a schematic rear view of the vehicle mounted shelter of FIG. 6, mounted, as in FIG. 8, to a vehicle, in closed capsule configuration;

FIG. 16 is a schematic top view of the vehicle mounted shelter of FIG. 6, mounted, as in FIG. 8, to a vehicle, in closed capsule configuration; and

FIG. 17 is a schematic front left perspective view of the vehicle mounted shelter of FIG. 6, mounted, as in FIG. 8, to a vehicle, in closed capsule configuration.

### DETAILED DESCRIPTION OF THE INVENTION INCLUDING A BEST MODE

The present invention provides two or more sleeping decks arranged lengthwise, end-to-end, so as to have a footprint width that does not substantially exceed the width of the footprint of a vehicle above which the decks are connectedly mounted. The vehicle will be parked, for example at a campsite, before the decks are made available for use to provide a stable deck for sleeping. At the end of a trip, when the vehicle is being readied for travel, the decks are stowed one above the other in a first, travel-ready, stacked configuration, and in readiness for later deployment. When in use for sleeping purposes, the decks will be in a second configuration with the decks longitudinally arranged horizontally. The invention will be described from here on in relation to there being only two such decks, however, the scope of the invention allows for more than two decks to be included, as would be understood by the person skilled in the art.

Each deck is of sufficient width to accommodate an adult human couple (of average size) lying on their backs, side by side. For purposes of explanation, the adult persons contemplated herein would be between 1.7 metres and 1.9 metres in height and have a maximum weight of 100 kilograms each. Instead of two adults, each deck may accommodate two or more small children. Other suitable arrangements may be made making use of the spacious, two room accommodation. Conveniently, the length of the decks exceeds the width, much as the length of a conventional double bed exceeds its width and in similar proportions. The decks thus are preferable generally rectangular, in which embodiment they have two pairs of opposing edges. Their longer edges are in general alignment with the sides of the vehicle below and their shorter edges are aligned in parallel with the axles of the vehicle. However, the decks need not be rectangular to be functional, many a deviation being permissible. For example, one end at least may be of a semicircular or oval shape. Alternatively, at least one end may have first and second edge meeting in prow-like configuration. The shape may be adopted for suiting particular storage and user functions.

It is preferable that the decks may be disposed one above the other to define a common footprint when stowed. However, this is not to exclude the possibility that the decks may be of different sizes and shapes, provided they serve the requirement of providing sleeping spaces for first and second couples within the footprint area of the vehicle when mounted thereon.

The lengthwise, end-to-end preferred arrangement of the sleeping decks allows the couples to be accommodated lying head-to-toe, head-to-head, or toe-to-toe, orientated generally transverse to the axles of the vehicle. The advantage of this arrangement is that it restricts the footprint width of the sleeping accommodation to coincide generally with that of the vehicle. This is turn allows for vehicles to be parked closer to each other and to improve the degree of utilisation of camping space. This can be highly advantageous at mass gatherings such as festivals. There are technical advantages within the confines of the accommodation too, and these will be discussed after discussion of the embodiments to be described next.

In an embodiment, when the decks are disposed in travel-ready stacked configuration. One above the other, they help define a capsule mounted above the vehicle, with the longer dimensions of the capsule being in substantial alignment with the lateral sides of the vehicle. The footprint width of the capsule in other words is located to be aligned with that of the vehicle.

The decks may be separated by side walls extending between the decks, so that a space is defined between the decks and bounded by the side walls. The upper deck therefore functions as a lid for the capsule and the lower deck as a floor. The space between the decks is advantageous in providing suitable storage for one or both of the mattresses used by sleepers occupying the decks.

In an embodiment, the upper deck is able to be slid into capsule-defining closing position, making use of known sliding formations and roller-assisted mechanisms. In an example, grooves are provided in the lateral side walls to receive the lateral edges of the upper deck. The capacity to slide may be assisted by suitable rollers mounted either within the grooves or to the lateral edges of the upper deck. Alternatively, the upper deck may have grooved formations adjacent its edges so that it slides into position along the top edges of the side walls and may then be suitably fixed into place for travel using conventional fixing means such as bolts, fixing screws, hasps and staples, and the like.

The side walls provide occupants with fall protection along the edges. Both decks are preferably provided with side walls as well as end walls, each deck having an open traylike configuration. The side walls of one of the decks may be hingedly connected to the deck allowing them to be folded down for stowage.

In a preferred embodiment, the decks are hingedly connected together at their adjacent transverse edges so that instead of sliding over each other for stowage, the upper deck pivots on the hinged connection to be folded over the lower deck. In the embodiment, the side walls of the decks may be located so that they do not collide when folded together. The walls separate the major surfaces of the decks to provide a space between them as discussed earlier.

The decks, when separated to assume open configuration for providing sleeping accommodation, may be covered or uncovered. In covered form, there may be a collapsible canopy stowed in the between-decks space that is ready for erection. The canopy may be configured to be automatically erected when the top deck is folded back from the lower deck. Similarly, in the case of the sliding decks embodiment, a canopy configuration is provided that is automatically activated to be at least partially erected by the sliding of the upper deck away from the lower deck.

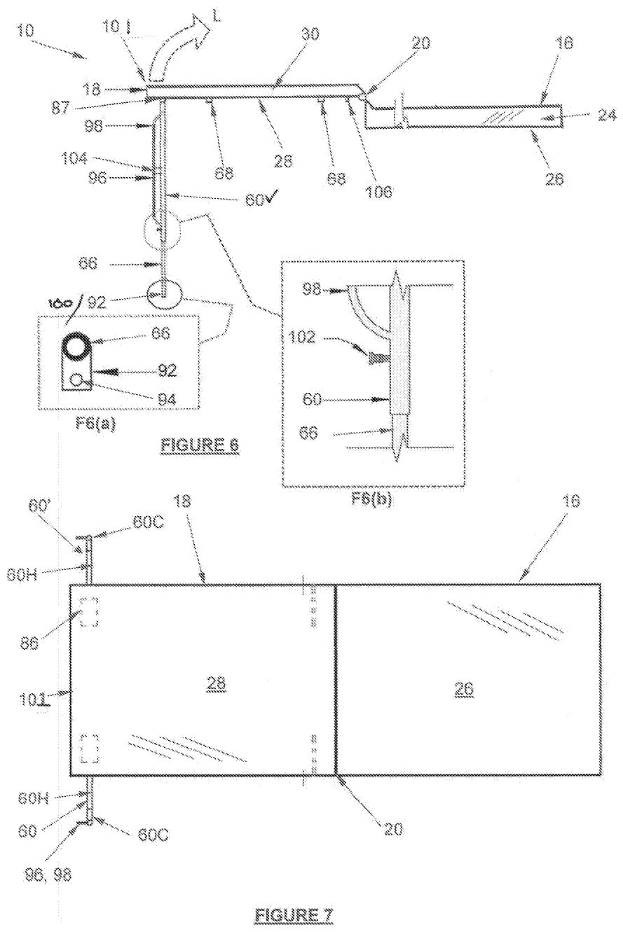

Referring to FIGS. 1 to 4 (no FIG. 5 is included), a preferred embodiment of the invention will be described, where the roof-top sleeping accommodation of the disclosure is labelled 10 and shown mounted for use atop utility vehicle 12 of typical design and configuration. The make and model of the vehicle are not essential features of the invention, as the accommodation may be adapted for different makes and models. The vehicle may be a sports utility vehicle (“SUV”) that has a single internal load carrying space rather that a load carrying tray behind the cabin. The accommodation may be adapted to suit even a sedan vehicle or a truck having a roof on to which the accommodation unit may be mounted and borne for travel. The options of mounting the sleeping accommodation over a trailer or above the load-carrying tray of a utility vehicle are also included in this disclosure. The invention will work in the same way as described for use on a vehicle roof but may be supported above a trailer instead in other forms of the invention. The unique double deck able to accommodate two couples for sleeping, and the small internal footprint within the footprint of the trailer is the same.

In this first embodiment, the sleeping accommodation is illustrated with a canopy useful to protect the user during sleep. Canopy 14 is supported erectly on a base with a first, rearward division 16 and a second, forward division 18. These divisions are connected by a hinge mechanism 20, comprising a standard strip hinge for upward and forward projection, that extends the width of the narrower of the divisions, 18, as shown in FIG. 4. It will be appreciated that discrete, shorter hinge units may alternatively be used, or other suitable mechanism to enable the hinge movement.

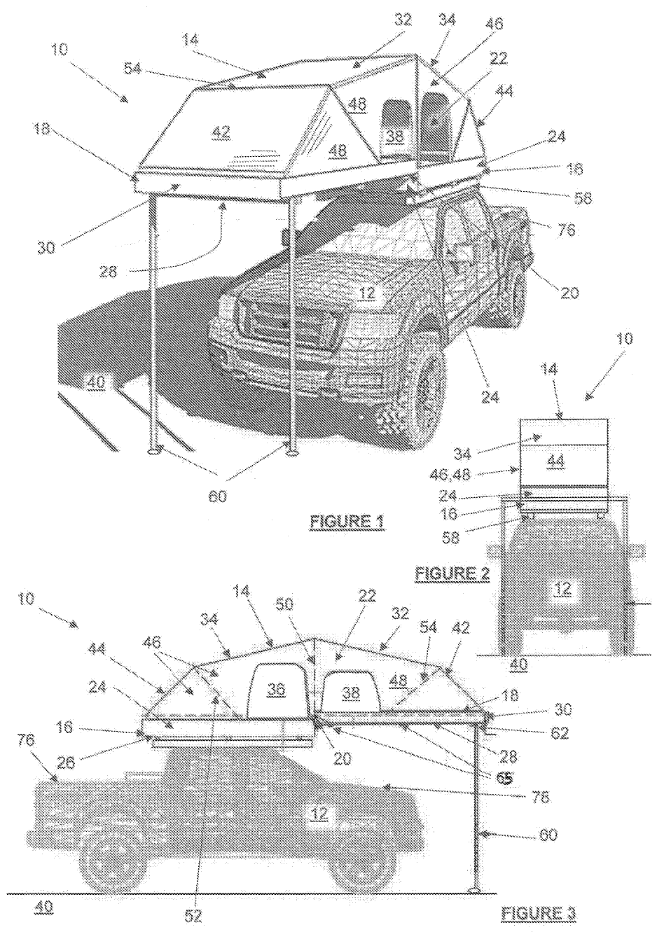

Internally, between canopy 14 and each of divisions 16, 18 there is a divisible sleeping space 22, having a generally planar floor defined by the respective decks 26, 28. Each deck has a width that is a little less than that of the supporting vehicle 12, as illustrated in FIG. 2. However, it will be appreciated that certain vehicles may be a little narrower than the base divisions. A small distance of lateral spill-over may be tolerated, depending on the traffic regulations in different jurisdictions. For stability when occupied by sleeping bodies, it is preferable for the width of the vehicle to exceed that of the decks.

Division 16 defines a low-sided tray having a wall 24 rising vertically from the periphery of rear deck 26. Similarly, division 18 defines a low-sided tray having wall 30 rising vertically from the periphery of forward deck 28. The walls are formed from a rigid and preferably lightweight panelling material, for example a metal such as aluminium or a plastics compound such as polyvinyl chloride. The tray walls need to be able to prevent a human body from rolling off the deck during normal sleeping or dreaming behaviour. These are preferably of a strong and impact resistant material, and as illustrated are made of aluminium. Other materials such as plywood could be used instead. The walls preferably extend around the three exposed sides of each deck. However, in some embodiments, the wall may be discontinuous along the periphery of the decks and may include gaps. Such gaps may be provided for assisting ventilation and sweeping out of dust and dirt and facilitating water drainage, for example after washing.

In this embodiment, canopy 14 has two sloping fabric roof sections 32, 34 and sloping front and rear end wall fabric sections 42, 44 connected to generally vertical fabric side wall panels 46, 48 (on each side) associated with rear and front divisions 16, 18. The configuration of canopy and fabric wall sections may vary within the scope of this disclosure, as their configuration is not essential to the functionality of the inventive concept hereof. Canopy 14 is conveniently configured to be opened for use and the closed and in the compact form be transported.

The essence of the invention depicted in this non-limiting embodiment is the division of the base into two floor divisions defining a divisible sleeping space. The sleeping space is optionally divided in the region of the join between the base divisions by means of an erectable partition (not shown). The partition/panel may be of the same material as the canopy and wall sections, or it may be of a different sheet material. For example, the canopy and its associated wall sections may be of canvas or a synthetic fabric such as nylon and the partition/panel of the same or alternatively of a rigid sheet material such as aluminium, plywood, timber, plastics or a metal such as aluminium. Preferable the partition/panel is of low-density material. The partition/panel may be selected for promoting privacy between the sleeping spaces, such as when the spaces are being used by two adult couples. The partition/panel may be constructed to provide soundproofing using known techniques. The partition/panel fits into vertically grooved formations in the opposite side walls of lower tray division 16. However, it may alternatively be fitted within upper division 18.

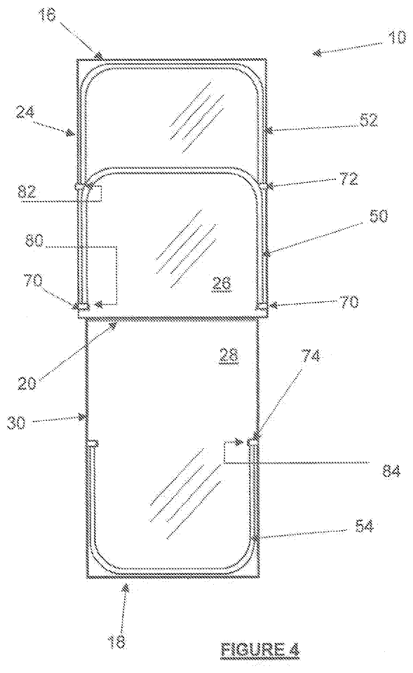

By providing the separate sleeping spaces extending in general alignment with the length dimension of vehicle 12, that is, in the general direction of its travel when the assembly is dissembled and stowed, the separate spaces are able each to accommodate a double bed-style sleeping arrangement for the occupants in head-to-toe, head-to-head, or toe-to-toe alignments in relation to the partition, when used. The width of the division would typically be about 1.8 metre and the length about 2.05 metre. However, any suitable dimensions may be used to provide the proposed sleeping space for an adult couple, as previously discussed. The partition need not have an openable closure, as communication between the divisions 16, 18 is relatively easy to achieve using external flap-covered openings 36, 38 of a known form and can be seen advantageously in FIG. 3.

The assembly comprising the folded-together tray divisions is supported by roof rails 58 secured in conventional manner to the roof of the vehicle. The assembly is connected to the rails using conventional fasteners such as bolts and nuts. The assembly, when opened out into camping configuration has the front division 18 supported below by struts or legs 60. The struts extend from forward base division 18 to the ground 40 on which vehicle 12 is parked. As illustrated the telescopic and opening mechanism is manual, readily achieved by holding and moving of the arm to extend the parts. However an automatic actuated form of the invention is envisaged. The struts are adjustable in length, each having a telescopically extending lower section 66, the distance of extension being set using clamps of known design. The upper ends of the struts are received into sockets 62 in a forwardmost of a series of stiffening alloy crossmembers 68 fixed below the floor of division 28. Rearward division 26 has similar stiffening members 65.

For further levelling of the decks 26, 28 a levelling screw mechanism of known design (not shown) is incorporated into the supporting roof rails 58.

To dismantle and stow the assembly for travel, the struts are removed from their sockets or folded back on their hinges, to be held in clips of conventional design against the underside of the front base division 18.

In a further embodiment not illustrated, the direction of the sleeping space configuration is reversed. In this embodiment, the assembly is mounted in reverse orientation so that the second, or front division 18 in FIG. 1 is hinged to fold out to the rear of the roof of vehicle 12, so that it extends over the load space 76, instead of over bonnet 78.

Instead of having a hinged connection between the base divisions that provide the sleeping floors, as contemplated in the embodiment described above, one base division may slide over the other to transition from travel-ready configuration to in-use configuration. Considering the example shown in FIG. 1, if there were no hinge 20 connecting base tray divisions 16 and 18 forward division 18 may be configured to be slightly narrower in width and rear division 16, so that it may slide backwards and into the tray defined by the floor and sides of rear division 18. In this embodiment, the canopy and wall sections are detached from front base division 18 and collapsed to fold into the tray of rear base division 16, after which tray division 18 is positioned over the folded divisions, protecting them from the elements during travel. The exposed surface of base division 18 provides a hard, strong and supportive planar, horizontal surface on which other camping or travel gear may be stowed and secured for travel.

In FIG. 4 the assembly is shown in operative open position in plan view, with canopy removed, exposing the tubular support frame members 50, 52 and 54 in collapsed configuration. The members are U-shaped and have pairs of free ends connected to respective pairs of sleeves 70, 72 and 74 that are rotatably mounted to paired studs 80, 82, 84 that project inwardly into the tray space from opposing inner surfaces of the walls 24, 30 of tray 16, 18. The support members 50, 52, 54 may therefore be pivotally raised from their flat transport-ready stowed positions shown in FIG. 4, to the raised supporting positions depicted in FIGS. 1 to 3. The angle to which each of the frame members is raised in relation to the decks is settable using clamping screws or other means well known in the art. These are not shown in the drawings for simplicity.

The front 42 and rear 44 walls of canopy 14 are secured to the tray walls 30 and 24 respectively using known fastening devices, not shown. To prevent rain entering the enclosed tray area and accumulating on decks 26, 28, the canopy walls optionally have rain skirts (not shown) that extend from the lower portions of the walls and are arranged by the camper to fall on the outer side of the tray walls 30, 24, deflecting rain away.

Not shown but the apparatus in folded over condition, would be ready for transporting and would appear similar to single occupancy roof top campers of a known kind. Hinge 20 is not visible as such, but its internal position in the space intermediate decks 26, 28 is denoted connecting walls 24 and 30 by the arrow. The closed capsule is shown supported in mounted orientation on roof rails 58. The rails are in broken lines to indicate they may be manufactured and supplied separately from the capsule of the present disclosure and would be made to suit specific vehicle models. For transporting purposes, the folded divisions 16, 18 are secured together against relative movement using known securing devices. By way of non-limiting example, suitable known devices include lever latches and bolts. More complex mechanisms may be advantageously employed.

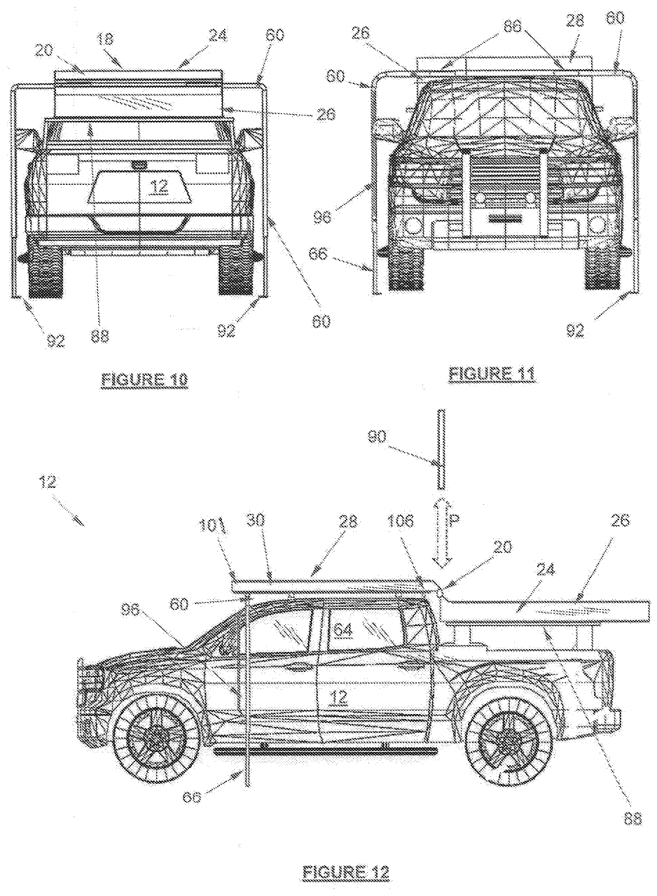

Referring to FIGS. 6 to 17, a second preferred embodiment of the invention will be described, illustrating the base divisions of the apparatus and method of its use. Like numbering will be used for components and features already introduced in previous Figures.

In FIG. 6, the apparatus 10 is shown unmounted and in open configuration, in isolation from the vehicle to which it may be mounted. The sleeping accommodation is illustrated without showing an optional canopy of the kind illustrated in FIGS. 1 to 4. A canopy, when available, may be supported erectly on the open base divisions 16 and forward division 18. The canopy may be substantially of the kind shown in FIGS. 1 to 4, or it may differ in shape and structural features without affecting the scope of this disclosure.

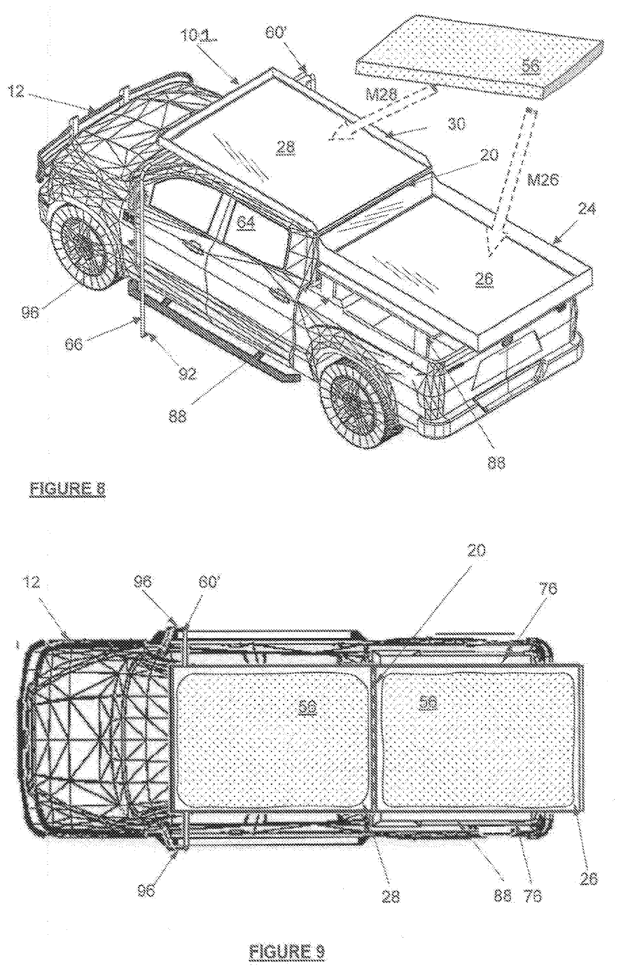

The accommodation divisions are connected by a hinge 20 of suitable known kind for upward and forward projection. As described in relation to previous embodiments, each division includes a shareable sleeping space with a generally planar floor defined by decks 26, 28, associated respectively with divisions 16 and 18. Each deck has a width that is ideally a little less than the width of the supporting vehicle 12, as illustrated in the overhead view of FIG. 9. The narrower width enables the apparatus to lie within the footprint of the vehicle, delivering advantages set out in earlier paragraphs.

Deck-supporting adjustable leg 60, which is provided for supporting forward division 18, is shown extending from socket sleeve housing 86 located below and secured to the peripheral front end portion of floor 28. The socket sleeve housing includes a circular socket 87 for snugly but rotatably receiving a section of leg 60, namely horizontal section 60H. Leg 60 is made from a circular hollow section (CHS) of nominal 25 millimetre diameter which is bent 90 degrees to reach the ground a little forward of and alongside vehicle cab 64, where it is connected to a supporting foot 92. Leg 60 therefore has a vertical section 60V and a horizontal section 60H connected by a 90 degrees bend 60C. The horizontal section extends well beyond socket housing 86, almost to the middle of rear division 28. It will be appreciated that leg 60 may be of alternative dimensions and shape, provided that the alternative specifications deliver appropriate functionality for achieving the support function and allowing the apparatus to deliver the advantages discussed elsewhere herein.

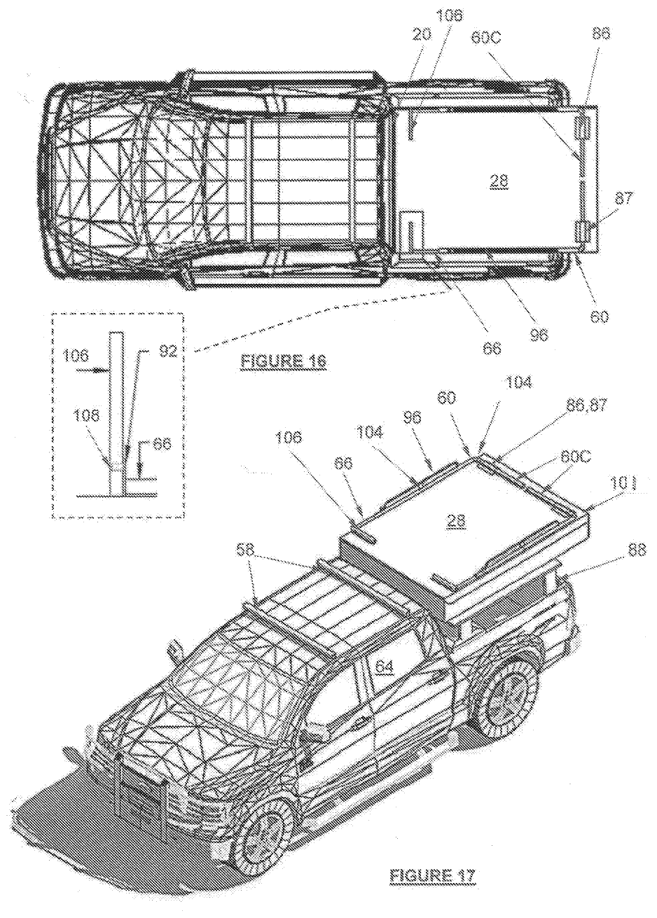

Leg 60 has a tubular terminal lower portion 100 that telescopes into the hollow internal space therein. Lower portion 100 terminates at its distal end in a supporting foot 92, which, as per detailed area F6(a) shows a vertical cross-sectional view of the bottom part of the leg. Foot 92 is a flat plate that includes an aperture 94 for receiving a pin of peg or other ground penetrating implement by means of which it can be secured against movement once its location has been determined for supporting deck division 28. For stowage of leg assembly 60 and associated foot 92, there is a protruding rectangular hollow section 106 that extends orthogonally from below deck 28. When, as shown in FIGS. 16 and 17, the divisions have been folded together in closed configuration in preparation for travel, hollow section 106 is now located above division 28. Footplate 92 is now in a position in which it is able to be secured to hollow section 106, as will be described further below.

Length adjustment of leg 60 is enabled by telescoping lower section 66 of smaller diameter than the remainder of the CHS of which leg 60 is comprised and an indexing plunger device 102 of know design and operation, operable to arrest travel of lower end section 66 relative to the main extent of leg 60. These features are detailed in detailed area F6(b). Adjusting the length helps in levelling deck 28 of division 18.

Because leg 60 in this embodiment has a circular profile, it is rotatable at its upper end within circular sleeve socket 86. This is important in facilitating transition of the apparatus from open configuration to closed capsule configuration in readiness for transportation, as will now be explained.

The user or operator of the apparatus or vehicle on which it is mounted, grasps leg 60 at a comfortable height and lifts the leg vertically upwards. A suitable grab formation may be the CHS rail 96, which is connected via bends 60C at either end to leg 60, as illustrated further in detail area F6(b). A spacing brace 104 is provided intermediate the opposite ends of rail 96 to locate between rail 96 and adjacent parallel leg 60. Rail 96 extends forward. When it is folded back with division 28 into capsule configuration, the rail stands proud of the exposed surface of division 28, as illustrated in FIG. 16 and FIG. 17, in relation to which it is further discussed. By extending forward from leg 60, rail 96 does not add to the lateral extension width of the apparatus beyond the sides of the vehicle. This provides the advantage of providing no added obstruction to persons passing the encamped vehicle.

The proximal end of horizontal leg section 60H, which is located in socket 86, swivels in the socket while the immediately adjoining end 101 of deck division 18 is raised relative to the end hingedly connected at hinge 20 to stationary deck division 16. The beginning of the locus followed by end 101, remote from hinge 20, is illustrated by directional arrow L in the direction of vertical orientation. A second person may similarly and simultaneously raise the corresponding second leg 60′, located on the opposite side of the apparatus to leg 60, making use of grab bar 98 on the opposite side, if necessary. The operators, working unison, raise division 18 to a vertical orientation before gently lowering it in a continuing arc until it comes to rest on stationary division 16, thereby establishing the apparatus in its closed capsule configuration, illustrated in FIGS. 13 to 17.

A portion 60C of leg 60H, that extends centrally beyond sleeve 87 and its housing 86, provides additional support for division 28 while the latter is being manoeuvred from open to closed configuration and vice versa. Once in closed (capsule) configuration, the two divisions are then temporarily and releasably connected together to prevent relative displacement while the vehicle is in motion. Connection may be established by any suitable means known in the art as has been previously observed in relation to the embodiment of FIGS. 1 to 4. Non-limiting examples include lever latches and bolts, which may be locked into position by means of a device such as a padlock and the like.

The apparatus 10 is shown mounted to a utility vehicle in open configuration in FIGS. 8 to 12 and in vehicle-mounted closed capsule configuration in FIGS. 13 to 17. Any suitable vehicle may be used and the apparatus may be adapted to fit particular vehicle models where an universal mounting such as a tub rack system is not available.

When mounted, the assembly comprising the folded-together tray divisions is supported by a tub-rack 88 of conventional design fitted into the load space (or tub) 76 of the SUV 12. The assembly is secured in conventional manner to the tub-rack using known fittings that are suited to the facilities of the tub-rack model presented. Within the tub, below the folded assembly, there remains utilisable space suitable for stowage of equipment and supplies. Access to load space 76 via operating the vehicle tailgate is not impeded. As in the embodiment of FIGS. 1 to 4, the rear division 16 is mounted to the vehicle, but this time not on to roof rails, but instead on to a tub-rack fitted to the vehicle to be located above the tub or load carrying space 76. As in the previous embodiment, the forward division 18 is removed, also by folding forward but in this embodiment to be supported above the roof of the cab 64, instead of above the bonnet.

In a similar vein to the first embodiment, division 16 in the embodiment defines a low-sided tray having a wall 24 rising vertically from the periphery of rear deck 26. Similarly, division 18 defines a low-sided tray having wall 30 rising vertically from the periphery of forward deck 28. The walls are formed from a rigid and preferably lightweight panelling material, examples of which have been mentioned in relation to the first embodiment. The tray walls contain a mattress 56 within the sleeping space and are high enough to further at least temporarily impede a human body from rolling off the deck.

As in the first embodiment, a partitioning structure, shown in FIG. 12 in the form of a flat panel 90, may be located between divisions 16 and 18 for achieving a degree of relative privacy interdivisionally. Such structure may be supported in erect fashion by providing vertical slots in opposing portions of the side walls 24, 30 into which an edge portion of the structure may be received and held, pending withdrawal and stowage for allowing closure of the apparatus to capsule configuration, for transportation. The directional arrow P indicates in a non-limiting manner the direction of insertion into operative space-dividing orientation and position. In the example illustrated, panel 90 abuts hinge 20.

The separate sleeping spaces defined by divisions 16 and 18 (with or without deployment of panel 90) and extending in general alignment with the length dimension of vehicle 12, that is, in the general direction transverse to the vehicle axle or axles, are able each to accommodate a double bed-style sleeping mattress 56 as shown in FIGS. 8 and 9. In FIG. 8, mattress 56 is shown ready for installation into either division 26 or division 28, is indicated by directional arrows M26 and M28 respectively. In FIG. 9, first and second mattresses 56 are shown installed in operative arrangement for the occupants to lie on in head-to-toe, head-to-head, or toe-to-toe alignments in relation to the joining hinge 20. The mattress type, structure and materials are not to be considered limiting. However, it will be appreciated that the weight and thickness of the mattress are factors that the user of the apparatus and operator of the vehicle on which the apparatus is mounted ought to take into account when planning a camping excursion.

FIGS. 14-17 illustrate further features relating to stowage of the apparatus for transportation. FIGS. 16 and 17 provide views of the top of the apparatus when in closed configuration with the support arm 60, 66 laid flat on the deck of folded-back division 28. When in this configuration, grab rails 96 are upwardly orientated and serve as additional roof rails between which gear may be stowed externally and to which such gear may be secured using appropriate strapping or ties. Of course, the mattresses and canopy are stowable within the capsule defined by divisions 26. 28 when in closed configuration.

The detail FIG. 16 illustrates detail of the stowage orientation of the lower end 66 of leg 60 and the attached foot plate 92. The foot plate is brought into abutment with rectangular hollow section 106 so that peg hole 94 aligns with an aperture 108 in section 106. A suitable releasable securing device such as a bolt or split pin (not shown) may then be inserted through both aperture and hole to secure plate 92 to section 106 for travel.

It is an advantage of the present invention that within the sleeping accommodation there is a greater degree of privacy for the respective couples occupying the first and second decks in that they may maximise their spacing from each other by for example sleeping toe to toe. Compare this to the case of a prior accommodation arrangement extending laterally from the vehicle footprint, and in which the couples lie side by side in tinned sardine fashion. The use of a barrier membrane between the feet of the respective couples adds to the isolation and privacy (to the extent it exists, whatever the arrangement).

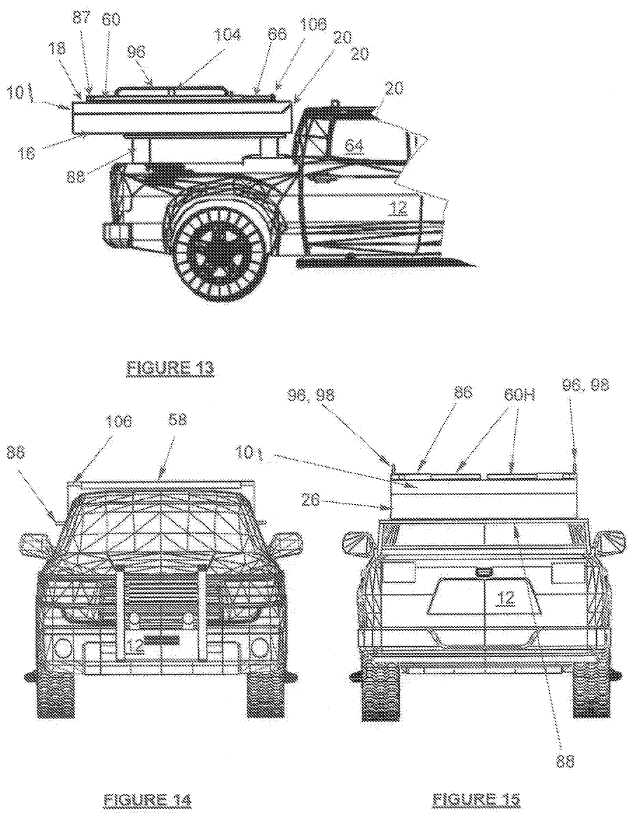

Another advantage is illustrated in FIGS. 14 and 15, where it can be seen that when the apparatus is mounted above the load space using a tub-rack 88, the apparatus does not extend significantly about the height of the roof of the vehicle cab, reducing wind resistance.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions and improvements fall within the scope of the subject matter herein.

Some embodiments may be described using the expression “coupled” and “connected” along with their derivatives. For example, some embodiments may be described using the term “coupled” to indicate that two or more elements are in direct physical contact. The term “coupled,” however, may also mean that two or more elements are not in direct contact with each other, but yet still co-operate or interact with each other. The embodiments are not limited in this context.

Upon reading this disclosure, those of skill in the art will appreciate still additional alternative structural and functional designs for a system and a process for an assembly providing sleeping space atop a vehicle through the disclosed principles herein. Thus, while particular embodiments and applications have been illustrated and described, it is to be understood that the disclosed embodiments are not limited to the precise construction and components disclosed herein.

Various modifications, changes and variations, which will be apparent to those skilled in the art, may be made in the arrangement, operation and details of the method and apparatus disclosed herein without departing from the spirit and scope defined in the appended claims.

REFERENCE SIGNS LIST:

| | |
|---|---|
| 10 | Vehicle mounted shelter accommodation |
| 12 | Utility vehicle |
| 14 | Canopy |
| 16 | Rearward division |
| 18 | Forward division |
| 20 | Hinge between 16/18 |
| 22 | Divisible sleeping space |
| 24 | Wall of division 16 |
| 26 | Deck |
| 28 | Deck (division, floor of) |
| 30 | Wall of division 18 |
| 32 | Sloping roof of canopy 14 |
| 34 | Sloping roof of canopy 14 |
| 36 | External flaps |
| 38 | External flaps |
| 40 | Ground |
| 42 | Sloping front end wall section |
| 44 | Sloping rear end wall section |
| 46 | Vertical wall section |
| 48 | Vertical wall section |
| 50, 52, 54 | Support frame members |
| 56 | Mattress |
| 58 | Roof rails |
| 60, 60C, | Deck supporting adjustable leg/Struts |
| 60H, 60V | |
| 62 | Sockets for upper ends struts 60 |
| 64 | Vehicle cab |
| 65 | Stiffening members |
| 66 | Telescopic ends of struts 60 |
| 68 | Cross-members |
| 70, 72, 74 | Sleeves |
| 76 | Load space |
| 78 | Bonnet |
| 80, 82, 84 | Studs for sleeves |
| 86 | Socket housing |
| 87 | Circular socket |
| 88 | Tub rack |
| 90 | Partition/Panel |
| 92 | Supporting foot |
| 94 | Aperture in 92 |
| 96 | Rail |
| 98 | Grab bar |
| 100 | Terminating end of leg 60 |
| 101 | End of deck |
| 102 | Plunger device |
| 104 | Space bracing |
| 106 | Protruding hollow section |
| 108 | Aperture |

1-49. (canceled)

50. A vehicle mounted shelter for accommodating sleeping couples or a family, the vehicle mounted shelter comprising:
a first deck attached to a second deck, the first deck forming a first division sized to accommodate a sleeping couple and the second deck forming a second division sized to accommodate a sleeping couple;
the first deck secured to a vehicle such that the first deck is substantially parallel to a roof of the vehicle, wherein in a closed state the second deck is positioned substantially above the first deck and wherein in an open state the second deck extends from an end of the first deck and both the first deck and the second deck are oriented substantially parallel to the roof of the vehicle;
a privacy barrier positioned between the first division and the second division, the privacy barrier substantially isolating the first division and the second division, including substantially limiting visibility and or sound transmission between the divisions,
wherein the vehicle mounted shelter is moveable between the closed state for storage or transport with the vehicle and the open state where the first deck and the second deck are each accessible for sleeping and further wherein in the open state the first deck and the second deck extend longitudinally along the vehicle and create a footprint that is substantially within a footprint of the vehicle.

51. The vehicle mounted shelter of claim 50, wherein the first deck and the second deck do not substantially exceed the width of the footprint of the vehicle.

52. The vehicle mounted shelter of claim 50, wherein the vehicle is a recreational vehicle, and the recreational vehicle includes a tub or rear loading area.

53. The vehicle mounted shelter of claim 50, wherein the first division and the second division are each sized to accommodate adults of 1.7 metres to 1.9 metres tall.

54. The vehicle mounted shelter of claim 50, wherein the first deck is attached to the second deck via a hinge.

55. The vehicle mounted shelter of claim 50, wherein the first deck and the second deck are slidably related.

56. The vehicle mounted shelter of claim 50, further comprising a fall barrier extending from at least one of the first deck and the second deck.

57. The vehicle mounted shelter of claim 56, wherein the fall barrier comprises a wall extending upwards from the at least one of the first deck and the second deck.

58. The vehicle mounted shelter of claim 56, wherein the fall barrier extends from both the first deck and the second deck.

59. The vehicle mounted shelter of claim 50, further comprising a collapsible canopy erected above at least one of the first deck and the second deck.

60. The vehicle mounted shelter of claim 59, wherein the privacy barrier is connected to both the canopy and the at least one of the first deck and the second deck.

61. The vehicle mounted shelter of claim 60, wherein the privacy barrier runs from the at least one of the first deck and the second deck to the canopy in vertical grooves.

62. The vehicle mounted shelter of claim 50, wherein the first deck and the second deck are positioned end to end in the open configuration and the first deck and the second deck are positioned one over the other in the closed configuration.

63. The vehicle mounted shelter of claim 50, further comprising support legs extending from the second deck to support the second deck.

64. The vehicle mounted shelter of claim 63, wherein the second deck extends from the roof forward over a bonnet of the vehicle and the support legs are kept substantially within the footprint of the second deck.

65. The vehicle mounted shelter of claim 63, wherein the second deck extends from the roof backward over a tub or rear loading area of the vehicle and the support legs are kept substantially within the footprint of the second deck.
